(19) United States
(12) Patent Application Publication
(10) Pub. No.: US 2014/0053669 A1
(43) Pub. Date: Feb. 27, 2014

(54) Method of and System for Inducing a Planned Avalanche

(71) Applicant: James Richard Hughes, Hilton Head Island, SC (US)

(72) Inventor: James Richard Hughes, Hilton Head Island, SC (US)

(21) Appl. No.: 14/069,341

(22) Filed: Oct. 31, 2013

Related U.S. Application Data
(63) Continuation-in-part of application No. 13/176,723, filed on Jul. 5, 2011, now Pat. No. 8,596,929.

(51) Int. Cl. B06B 1/16

(52) U.S. Cl. CPC B06B 1/16
USPC 74/1 SS

(57) ABSTRACT

A method and system for inducing a planned or controlled avalanche is disclosed. The system includes one or more sources of vibration mounted within a mass which is mounted within an aperture in the ground in the area where an avalanche has been determined to be likely to occur. One or more sensors is mounted between the source of vibration and the avalanche area (spaced from the vibration source), then the vibration source is operated at different frequencies to determine which frequency transmits the greatest force through the intervening terrain. Based on the analysis of the forces sensed at a distance from the vibration source, the best frequency for operation of the vibration source is determined and that frequency is used. Periodically, the process of testing the frequency versus force can be reviewed and the operating frequency adjusted. The present method and system envisions a plurality of vibrational sources arranged in a spaced array and uses more than one vibrational source to trigger a single avalanche at a desired time.

### CROSS REFERENCE TO RELATED PATENT

The present patent application is a continuation-in-part of my co-pending patent application Ser. No. 13/176,723 filed Jul. 5, 2011 and entitled “AVALANCHE CONTROL SYSTEM AND METHOD”. The specification and drawings of that patent application, which is sometimes referred to herein as the “First Avalanche Patent”, are specifically incorporated herein by reference.

### BACKGROUND OF THE INVENTION

1. Field of Invention

The present invention relates to a method of (and system for) inducing a planned (or controlled) avalanche in a region in which an uncontrolled avalanche of snow might occur. That is, a controlled avalanche may be induced at a time which is most convenient and as frequently as desired to avoid a large avalanche at an undesirable time.

2. Background Art

Ski slopes, roadways, housing and railways through canyons are at risk of an uncontrolled avalanche in some areas. An avalanche can occur spontaneously when a snow pack is unstable and there is enough vertical angle. Areas where the instability is the greatest are known as avalanche “birthing” areas

Naturally occurring avalanches are somewhat predictable, yet difficult to control. It is well known that earthquakes have caused several of history's great avalanches. Snowmobile riding in an avalanche-prone area has a propensity to initiate an avalanche, since the drive causes vibration which may make disturb the snow pack.

It is sometimes desirable to provide a controlled avalanche at a desired time in some situations. That is, it is desirable to have more, smaller avalanches than fewer, larger avalanches. Further, it may be desirable to have an avalanche at a time when few people or animals are present in the area below an avalanche-prone area, for example, in the early hours of a day while many are asleep or when ski facilities are not operating. Also, if the approximate time of a planned or controlled avalanche is known, precautions can be taken for that time, such as closing of roadway or trails in the affected areas or otherwise warning those who could be in an area to avoid the area.

Various approaches have been suggested to induce a controlled avalanche to mitigate uncontrolled avalanche events. One approach to causing a controlled avalanche has been to use a concussive event to trigger a planned avalanche, for example, using artillery ordinance, dynamite or a mortar shell. More recently, gas explosions in one of a variety of types have become popular to initiate an avalanche. For example, a fixed concussive device igniting explosive gases is one such system for using a gas explosion to initiate an avalanche, while a “Daisy Bell” concussive device carried by a helicopter is another such device which can initiate a controlled avalanche.

The use of ordinance, dynamite or a mortar shell requires special handling skills and storage and is the subject of increased regulation due to safety concerns.

One must also consider that some systems for initiating a controlled avalanche do not work well during times of heavy snowfall, such as those which require a helicopter. Operating a helicopter usually requires some visibility of the surroundings, while a heavy snowfall obscures the visibility of the pilot of the helicopter. So, in times when the risk of an uncontrolled avalanche increases (during heavy snowfall), a control system which uses a helicopter is less likely to be usable for that purpose.

Some of the systems of initiating a controlled avalanche are relatively costly to use—for example, the Daisy Bell system requiring a helicopter and pilot.

Additionally, some of these prior art systems employ elements and/or compounds which can be harmful to the environment, including the water supply. Various materials contained in explosives are toxic to people and/or animal and tend to remain in the water supply long after a triggering of the explosive, polluting the water supply and causing harm to those who use the water supply, directly or indirectly. For example, many explosives include aromatic hydrocarbons such as toluene as a component (for example, TNT) and toluene is a long lasting material which does not break down quickly and which is harmful to life, even in relatively small doses. Some of these materials are relatively soluble in water, while others are relatively insoluble in water, making the impact on the environment hard to predict, either regarding the short-term impact or the longer-term impact.

Accordingly, it will be appreciated that the prior art system for inducing an avalanche have undesirable disadvantages and limitations.

### SUMMARY OF THE INVENTION

The present invention overcomes some of the disadvantages and limitation of the prior art systems for inducing a planned or controlled avalanche of snow in those areas which have been identified as prone to avalanche activity.

The present invention allows for creating many small controlled avalanches to reduce the risk of a larger, uncontrolled and unpredictable avalanche.

The present invention would also appear to be “friendlier” to the environment in avoiding undesirable chemicals and inconveniently-timed avalanches which may jeopardize lives. Further, since an avalanche may close roadways and other accesses, it would be desirable to “schedule” such avalanches at a time which is convenient (like the dead of the night), rather than allowing such events to occur naturally at an inconvenient time such as at a time of peak activity.

The present invention includes a method of setting up a vibrational system to induce a controlled avalanche at a desired time.

The present invention also allows for the system to be tuned to compensate for differences in the ground surrounding an avalanche-prone or avalanche birthing area. The tuning can also compensate for variations in the attachment of one or more vibration-inducing sources with the surrounding ground.

The present system for inducing a controlled avalanche also appears to be relatively inexpensive to use (and reuse) and provides a minimal environmental impact, especially compared with alternate systems for creating an induced avalanche. This system also has the advantage that it can be operated in almost any kind of weather, not being dependent on moving people or equipment to the site of the desired avalanche.

Other objects and advantages of the present invention will be apparent to one of ordinary skill in the art in view of the following description of the invention, taken in combination with the accompanying drawings.

### BRIEF DESCRIPTION OF THE DRAWINGS

FIG. 1 is a pictorial representation or a perspective view of an area of an avalanche-prone area, showing one arrangement of system for inducing a controlled avalanche including a vibration unit;

FIG. 2 is an enlarged view of a portion of FIG. 1, looking generally downward on an avalanche prone area having a plurality of vibration units (or sources) mounted in an array;

FIG. 3 a cross sectional view of an system for creating vibration used in the avalanche-prone area of FIGS. 1 and 2;

FIG. 4 is a flow chart of one process useful in the present invention; and

FIG. 5 is a cross sectional side view of one vibration unit useful in the system of FIGS. 1 and 2; and

FIG. 6 s a top view of the vibration unit of FIG. 5, with its top cover removed.

### DETAILED DESCRIPTION OF THE PREFERRED EMBODIMENT

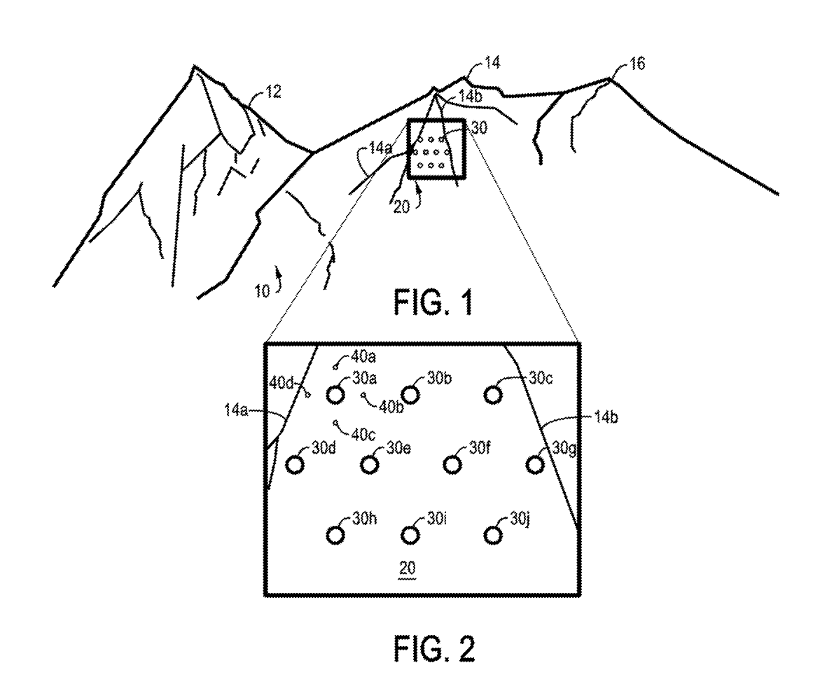

FIG. 1 shows a pictorial representation of a mountainous area 10 in which avalanches can be expected. The mountainous area 10 includes a plurality of peaks 12, 14 and 16, with an avalanche origin region 20 defined between the lines 14a and 14b delineating an avalanche-prone area. The avalanche origin region 20 (sometimes alternatively called an “avalanche-birthing” or “avalanche-prone” area) often has a substantial terrain slope, perhaps averaging approximately 40 degrees, and is located within a terrain area in which the slope of the terrain is generally more gentle. A plurality of vibration sources 30 are mounted within the avalanche prone area 20 in accordance with the present invention. These vibration sources 30 may be generally of the type described in the First Avalanche Patent referred to above and incorporated herein by reference or use other similar systems for producing vibration.

FIG. 2 shows an enlarged version of the avalanche-prone region 20 between the lines 14a and 14b of FIG. 1. A plurality of vibration sources 30 are indicated by the reference numerals 30a through 30j. Surrounding one of the vibration sources 30a are a plurality of vibration sensors 40a, 40b, 40c and 40d. Each of these vibration sensors is an instrument which measures the movement of the ground nearby the sensor and may be an accelerometer or a seismic sensor of the type used to detect, measure and locate earthquakes. Such accelerometers or seismic detectors are commercially available devices which are readily available and provide a time-varying electric signal representative of the displacement (or vibration) of the earth in the immediate area.

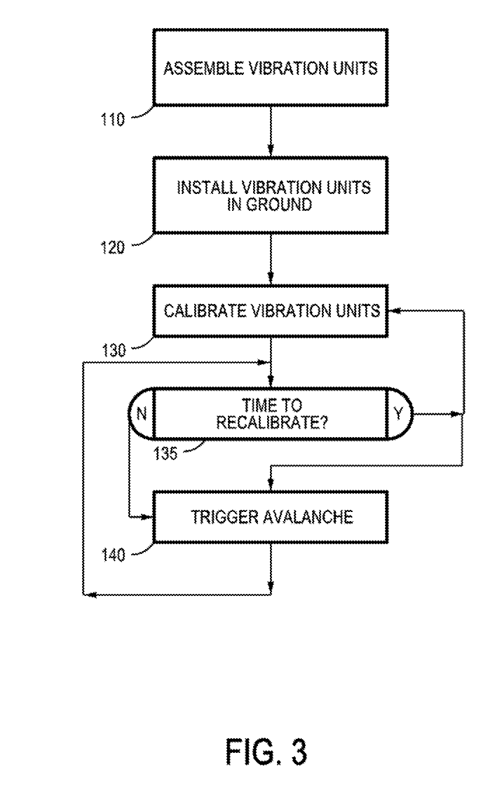

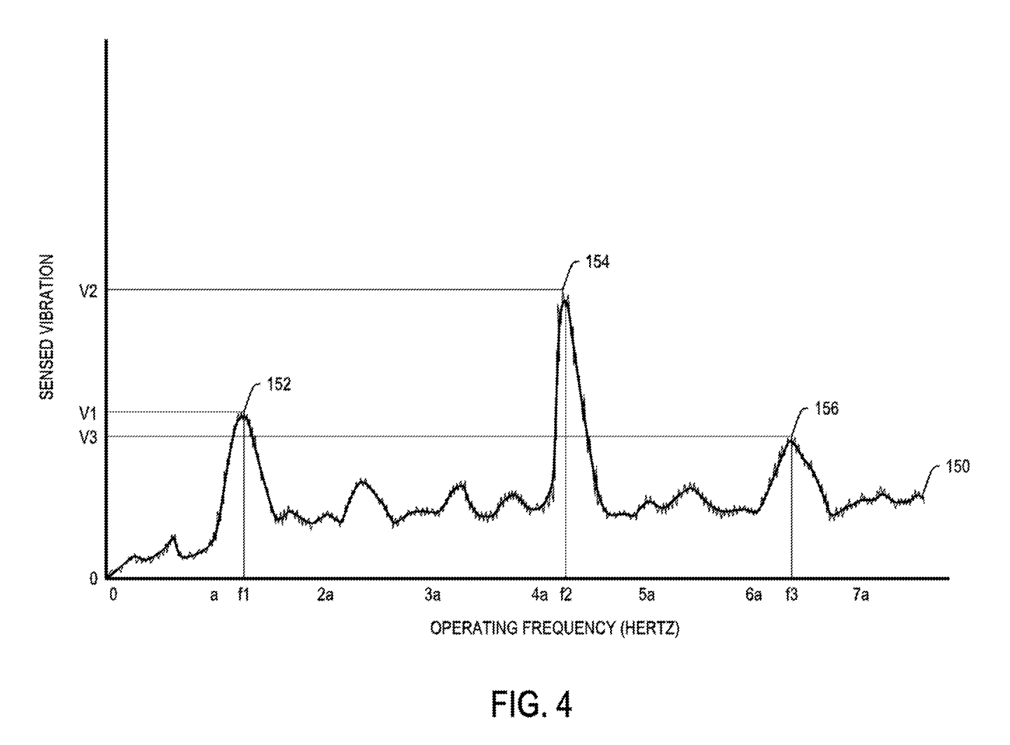

FIG. 3 shows a flow chart of one method of using the vibration equipment of the present invention. The process starts with the assembly of one or more vibration units (as described later in this document) at block 110. Next, the one or more vibration units are installed in the ground at block 120. This is accomplished by providing an aperture in the ground in the approximate shape of the cross section of the vibration units, a little wider and deeper than the unit to allow it to fit in the ground conveniently with little clearance (and, as will be discussed later, the vibration unit(s) may be secured in place with an adhering material—such as concrete or cement—to provide a better vibration-transmitting connection between the vibration unit and the ground). While it is desirable to have the top of the vibration units below the surface of the ground, it is also desirable to have the vibration units not buried too deep in the ground to allow each vibration unit to vibrate the upper layers of the adjacent ground and to transmit the vibrational forces outward to the extent possible, rather than downward (into the ground). At block 130 the next step is to calibrate at least one (or each) of the vibration units (see discussion below, especially in connection with FIG. 4). The vibration units can also be re-calibrated periodically to adjust for any changes in the units and/or the surrounding ground, perhaps as a result of ground changes, avalanches or belt tension or as a result of the seasonal weather cycles where the ground heats during the summer and cools during the winter, possibly changing the characteristics of the ground around the vibration unit. Thus, an optional timer is set to provide set time for a recalibration of the vibration source(s), and block 135 checks to see whether it is time to re-calibrate the unit. Block 140 responds to a triggering signal to trigger an avalanche by turning on the vibration source (and shaking the ground immediately around the vibration source). This triggering signal can result from sensing the amount of snow nearby, from a visual indication (an observer noting an accumulation of snow in the area) or from a remote signal (perhaps in response to a sensing of snowfall exceeding a preset limit or a time when the avalanche has been set to be triggered).

FIG. 4 shows a representative plot the sensed ground vibration response (the output) as a function of the vibration frequency of the vibration source (the input). The sensors 40a, 40b, 40c and 40d shown in FIG. 2 sense the effective ground vibration (or seismic activity) around the vibration source 30a as the frequency of the vibration is altered, then the vibration versus frequency is plotted. Each of these sensors (such as sensor 40a) may be an accelerometer or other suitable seismic sensing device with a suitable output or record. This frequency of vibration can be altered either manually (an operator changing the motor controls) or by an automatic stepping function, as desired. It is believed that FIG. 4 shows a representative plot for a typical ground sample in an avalanche-prone area 20. The plot 150 of operating frequency of the vibration source (along the x-axis) versus sensed vibration (along the y-axis) is shown in this view and includes a relative maximum 152 at f1 (where the vibration level is v1), an absolute maximum f2 and another relative maximum f3. As shown in this FIG. 4, a vibration response or level v1 is sensed at the frequency f1, the vibration response or level v2 at the frequency f2 and the vibration response or level v3 at the frequency f3, with the vibration response or level v2 being the highest of those shown in this FIG. 4. Under these circumstances, the frequency f2 is chosen as the frequency where the greatest vibration is transmitted through this particular ground configuration.

Of course, it may be easier (and more convenient as well as safer) to measure the ground response during periods of dry weather during a time when snow is not present—which would be a time when avalanches are not expected because there's no snow present and the temperatures might be warmer than those during the peak avalanche seasons. It is expected that the ground may have a different response to vibration based on temperature and based on the presence of (or absence of) a pile of snow, and the frequency at which the ground is most responsive may require adjustment for changes in temperature and ground loading. That is, the peak response may shift as a result of the ground becoming colder and/or piled with snow, and it may be desirable to compensate for changes in such variables in setting the preferred rate of vibration. It is also anticipated that different ground characteristics, even in adjacent areas, may produce different ground characteristics, requiring different frequencies to be used for different vibration sources, even though the sources may be close to one another. Accordingly, it will be apparent that the desirable operating frequency may be the observed best frequency with an offset to compensate for the temperature and for the snow pack on the ground in some instances.

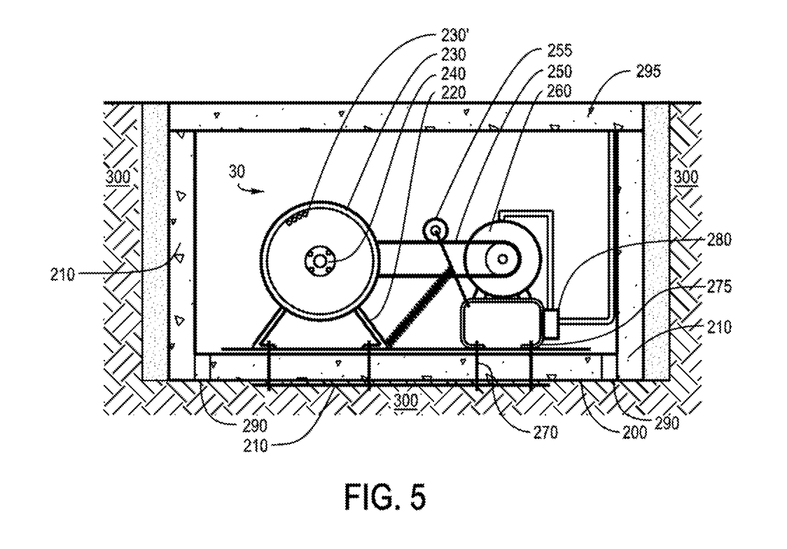

FIG. 5 is a cut-away side view of one vibration unit 30 useful in the present invention mounted within an aperture in the surrounding ground 300. The vibration unit 30 includes a housing 210 to which legs 220 mount a flywheel 230 using bearings 240. Drive belt 250 couples the flywheel 230 to a motor 260 which is mounted to the housing 210 by mounts 270. An optional tension device 255 keeps the drive belt 250 taut. The motor 260 may generate heat and the assembly may be mounted in a location where the temperature varies depending on the time of year, so the belt 250 may need tightening over time or use, hence a tension device 255 may be provided—and periodic replacement and/or adjustment of the drive belt 250 may be desirable.

The flywheel 230 is desirably asymmetric to produce vibration as it rotates. One way to achieve such asymmetry is to remove circular portions 230′ from one side of of the flywheel 230, making the side of the flywheel 230 with the removed material lighter than the side of the flywheel 230 on which no material has been removed. Another way to create asymmetry (or unbalance) in the flywheel 230 would be to mount weights on one side, making that side of the flywheel heavier than the side without the weights. Yet another way to create an asymmetric flywheel is to mount the flywheel 230 off center, so that one side of the flywheel is heavier than the other side.

The motor 260 may be a direct current motor operating at a relatively low voltage, such as 24 volts. A 24 volt power supply can be obtained through the use of two pair of 12 volt automotive batteries (or by other suitable powering, such as wiring into a commercial electrical supply or through the use of photovoltaic cells deriving power from solar energy which is then stored in batteries to be used when the sun is not shining). The motor 260 is one which can be driven at various speeds so that the optimum speed can be determined during a set-up or calibration period. That is, the motor 260 is operated at a range of different frequencies f1, f2, f3, . . . and the response of the ground in the vicinity is measured to determine which frequency provides the best transmission of vibrational forces (as discussed above in connection with FIG. 4). That is, the ground 300 may have a differing response to vibrational forces at different frequencies, due to local differences in the materials and/or the adhesiveness of the ground in the vicinity. If the ground is very colluvial, it may be less transmissive of forces, including vibrational forces, than if the ground is more solid like granite, and the peak transmissive force is likely to occur at a different operating frequency. It is desirable in this application to determine the frequency at which the best transmission of vibrational forces occurs for each vibrational source at the location where it is situated and then, if necessary, adjust for variations in temperature and loading to determine the operating frequency for a controlled avalanche causing vibration and to induce the avalanche at a controlled time.

The vibrational unit 30 has the housing 210 which may be a concrete culvert formed with a base which is either integral with it or securely attached to it. A steel plate 200 may be provided to securely mount the legs 220 and the motor 260 along with other components such as a battery and electrical conduit. The electrical conduit may serve the functions of signal transmission (to report the operating frequency, to set an operating frequency or to provide a signal triggering an avalanche) and may also serve as a power transmission function, either for providing primary power (providing the main drive for the motor driving the flywheel) or for providing back-up power (to supplement the power stored in a battery and/or generated by the photovoltaic cells).

The top or upper portion of the vibration unit 30 is shown mounted approximately flush with the surrounding ground 300. A cover 295 is shown atop the vibration unit to keep undesirable materials—soil and water (such as snow) from filling the vibration unit 30. In addition, the lower portion of the housing 210 is provided with drain holes 290 to allow any water which enters the vibration unit 30 to drain from the vibration unit instead of accumulating and interfering with the operation of the components, including the flywheel 230, motor 260 and the included electrical system and components. Additional apertures (not shown) may also be provided to allow electrical conduits to enter the vibration unit, but such apertures would often be positioned above the bottom of the vibration unit 30 to minimize water problems.

The process of installing a vibration unit 30 in the ground 300 generally includes the step of preparing an aperture in the ground 300 slightly larger than the cross sectional shape of the vibrational unit 30 and approximately as deep as the height of the vibration unit 30. Then the vibration unit 30 is inserted into the aperture. If there is clearance between the vibration unit 30 and the ground 300, that clearance can be removed by filling the clearance with a suitable adhesive material, such as cement, shown by the reference numeral 292 between the ground 300 and the vibration unit 30 in FIG. 5. This adhesive material 292 provides the advantages of securing the vibration unit in place (so the vibration unit 30 less like to become dislodged, even in the event of an avalanche or water flow in the area) and to improve the force-transmission characteristics from the vibration unit 30 to the ground 300. The adhesive material 292 also can serve a sealing function, to keep water from accumulating within the aperture. While the vibration unit 30 does not have to be cylindrical in shape, it is shown as such in this example to allow for a circular hole to be used as the aperture in the ground 300. The circular shape also facilities use of a concrete culvert to be used in the present invention, with such devices being readily available and at a relatively low cost, since they are mass produced and widely used in other applications.

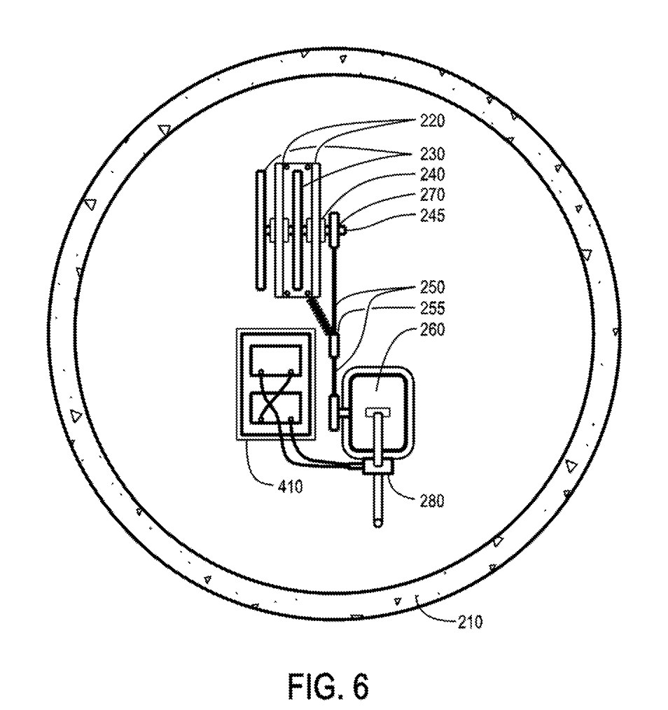

FIG. 6 shows a top view of the vibration unit 30 used in the present invention (with the top removed to view the contents). This view suggests the cylindrical shape of the vibration unit 30 in its preferred embodiment, given the round cross section of the wall or housing 210. Within the wall 210 are the motor 260 with the drive belt 250 and tension device 255 coupled to the belt 250, with the drive belt 250 transmitting rotational force from the motor 260 to the flywheel 230. The flywheel 230 is mounted by its legs 220 to the base 200 and bearings 240 are mounted to the flywheel 230.

Also shown in FIG. 6 is a battery (or power supply) 410 which consists of two automotive 12 volt batteries connected in series to provide approximately 24 volts. The voltage for the batteries and their power type are chosen based on the requirements of the motor 260, which in this case has been chosen as a 24 volt direct current motor. Of course, other types of motors 260 could be used to advantage in the present invention, and one might even use an alternating current motor if alternating current was available, either through a connection to a commercial power grid or through the use of an inverter, converting direct current into alternating current.

Of course, many modifications are possible to the present invention without departing from its spirit and some of the features described can be used to advantage without the corresponding use of other features. While a preferred material of concrete has been discussed in connection with the foregoing example, there are many substitutes which could be used to advantage, including metals and alloys, if desired, including a steel housing (like a steel culvert). Some plastics may also be usable in the present invention. While the housing which has the vibratory source mounted can be a single piece, it also could be formed of multiple pieces which are secured together. Further, those skilled in the relevant art will appreciate that the present invention can be operable without being at its greatest effectiveness. For example, the tuning of the present invention will disclose the responsiveness of the soil to the vibrational forces applied, and it is possible to use an effective frequency without using the optimum frequency. It is also suggested that the system be re-tuned at periodic intervals, such as annually, to compensate for changes in the soil and/or attachment or changes in the operating characteristics of the vibrational source. It may be possible to predict the changes and adjust for the suspected changes in the operational characteristics without redoing the testing. Accordingly, it will be appreciated that the description of the preferred embodiment is for the purpose of illustrating the principles of the present invention and not in limitation thereof.

Having thus described the invention, what is claimed is:

1. A method of inducing a controlled avalanche in an area where snow has been determined to be likely to avalanche, the steps of the method comprising:
mounting a source of vibration within the ground in the area where an avalanche is likely to occur;
setting up the vibration source by operating it at different frequencies and determining a desirable frequency based on the ground vibration detected at a distance from the source of vibration; and
operating the source of vibration at a frequency based on the determined desirable frequency when a controlled avalanche is desired in the area.

2. A method of inducing a controlled avalanche including the steps of claim 1 and further including the step of mounting a plurality of vibration sources in the area at spaced locations.

3. A method of inducing a controlled avalanche including the steps of claim 2 and further including the step of setting one vibration source at one frequency and a different vibration source at another frequency.

4. A method of inducing a controlled avalanche including the steps of claim 1 wherein the step of mounting the source of vibration in the ground includes the step of securing a housing to the ground.

5. A method of inducing a controlled avalanche including the steps of claim 4 wherein the step of securing the source of vibration in the ground includes the step of assembling a flywheel to a motor and mounting the assembled flywheel and motor to a housing.

6. A method of inducing a controlled avalanche including the steps of claim 5 wherein the step of mounting the source of vibration includes the step of forming a round hole and mounting the assembly in a cylindrical concrete member and inserting the cylindrical concrete member in the round hole.

7. A method of inducing a controlled avalanche including the steps of claim 6 wherein the step of securing the source of vibration includes the step of using cement to secure the concrete member in place.

8. A method of inducing a controlled avalanche including the steps of claim 1 wherein the method further include the step of draining unwanted material from a housing mounting the source of vibration.

9. A method of inducing a controlled avalanche including the steps of claim 1 further including the step of enclosing the source of vibration within a housing which includes a removable lid.

10. A method of inducing a controlled avalanche including the steps of claim 1 wherein the step of determining the frequency at which the vibration source is to operate includes adjusting the frequency for the temperature.

11. A method of inducing a controlled avalanche including the steps of claim 1 wherein the method includes the steps of mounting a plurality of vibration units within a single avalanche-prone area, determining an operating frequency for the plurality of vibration units and triggering the plurality of vibration units at about the same time to create a single controlled avalanche.

12. A system for inducing a controlled avalanche in a portion of ground where an avalanche is likely to occur, the system comprising:
a source of vibration mounted within the ground including a drive system operating at different frequencies;
means for varying the frequency of operation of the drive system for the source of vibration and determining at which frequency the ground has the greatest vibration;
operating the source of vibration at a frequency based on the determined frequency at which the ground vibration is the greatest; and
a triggering signal operating the source of vibration when a controlled avalanche is desired.

13. An system including the elements of claim 12 and further including a plurality of spaced vibration sources, where the triggering signal operates the plurality of vibration sources to trigger a controlled avalanche.

14. An system of the type described in claim 12 wherein the source of vibration includes an asymmetric flywheel.

15. An system of the type described in claim 12 wherein the source of vibration is mounted within a concrete cylindrical housing.

16. An system of the type described in claim 12 wherein the vibration source includes a removable top.

17. An system of the type described in claim 12 wherein the vibration source is mounted within a housing which resists intrusion of soil or water.

18. An system of the type described in claim 12 wherein the vibration unit includes a housing with at least one drain for allowing unwanted stuff to drain from the housing of the vibration source.

19. A system of the type described in claim 12 wherein the vibration source includes a flywheel where material has been removed from one portion to create an asymmetric flywheel which vibrates. To trigger a controlled avalanche when the vibration unit is operated at a frequency which is likely to induce an avalanche.
